(19) United States
(12) Patent Application Publication
(10) Pub. No.: US 2014/0033805 A1
(43) Pub. Date: Feb. 6, 2014

(54) METHODS OF EXTRACTING FAT SOLUBLE VITAMINS

(71) Applicant: Waters Technologies Corporation, Milford, MA (US)

(72) Inventors: Tarang Nema, Singapore (SG); Evelyn Mei Ling Goh, Singapore (SG)

(21) Appl. No.: 13/940,938

(22) Filed: Jul. 12, 2013

Related U.S. Application Data
(60) Provisional application No. 61/671,400, filed on Jul. 13, 2012.

(51) Int. Cl. G01N 1/28

(52) U.S. Cl. CPC G01N 1/28
USPC 73/61.55; 73/863.21

(57) ABSTRACT

The present invention provides novel, simple and reliable methods for extraction of fat soluble vitamins (FSVs) from a sample matrix obtained from food products (e.g., vitamin-enriched foods and fortified food matrices) or biological samples. In certain aspects, the invention provides solid phase extraction (SPE) methods. In certain embodiments, the invention relates to two-step elution methods, which provide excellent recovery of all fat-soluble vitamins from complicated food matrices (such as, vitamin-enriched foods and fortified food products) or biological samples in a simultaneous manner. In certain embodiments, the invention uses OASIS® materials as sorbent beds for separating and/or extracting FSVs from the sample matrix.

### BACKGROUND OF THE INVENTION

Fat-soluble vitamins (FSVs) are micro-nutrients essential for normal functions and growth in humans. The presence of fat-soluble vitamins (such as, vitamins A, D, E, and K) in humans is of vital importance because of their catalytic functions in anabolic and catabolic pathways. They are required by all age groups. Although FSVs are beneficial to human health, they can become toxic if taken in excess amounts. On the other hand, inadequate intake of FSVs can lead to deficiencies. As a result, the practice of enriching foods with FSVs in order to provide the recommended daily allowance (RDA) has become commonplace.

Because of the diversity of food and beverage products fortified with FSVs, there is a need to have stringent control over the quality and quantity of fortification. A simple, reliable and sensitive determination method of FSVs in food products and/or biological samples is essential for law enforcement, regulatory, nutritional and economic reasons.

In the past two decades, various analytical methods have been developed for the above-discussed purposes. Such analytical methods include, capillary electrophoresis, spectrophotometry, fluorimetry, colorimetry, and chromatography. Among these, determination by high-performance liquid chromatography (HPLC) is a frequently used method in the detection of fat-soluble vitamins in various matrices.

Notwithstanding recent developments, methods used in the industries have not yet achieved a simultaneous extraction and determination of a plurality of FSVs, e.g., seven or nine FSVs, contained in a sample matrix. Moreover, the analytical methods used so far are tedious and time consuming. For example, methods based on HPLC and UV typically take 15 to 60 minutes per run and generally require separate analyses for each group of fat-soluble vitamins.

Furthermore, most of the reported methods involve the process of sample saponification, liquid-liquid extraction, and HPLC analysis. In particular, saponification and hexane extraction are the most widely used techniques. Saponification, used for removing interfering compounds in a sample, results in a liberation of FSVs. However, such techniques are time consuming and often require the use of toxic solvents that pose both human and environmental risks. Thus, there is still an unmet need in the industry for a simple, sensitive and reliable method to extract and analyze FSVs from a sample matrix, including, e.g., food products and biological samples.

### SUMMARY OF THE INVENTION

The present invention provides novel, simple, reliable and sensitive methods for the extraction of FSVs from a food product (e.g., a fortified food matrix, and a vitamin-enriched food sample) or a biological sample.

In particular, the invention provides simultaneous extraction, separation, determination, and/or identification of FSVs from complicated matrices, such as, a fortified food product and a biological sample.

In one aspect, the invention provides a method of extracting FSVs from a fortified food matrix or a biological sample. The method comprises the steps of:

i) preparing an analytical sample containing the fortified food matrix or the biological sample;

ii) eluting the analytical sample through a water-wettable polymer with a first solvent; and

iii) eluting the water-wettable polymer with a second solvent;

wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

In another aspect, the invention provides a method of extracting FSVs from a fortified food matrix or a biological sample including the steps of:

i) preparing an analytical sample containing the fortified food matrix or the biological sample;

ii) eluting the analytical sample through a solid phase extraction cartridge with a first solvent; and

iii) eluting the solid phase extraction cartridge with a second solvent. The solid phase extraction cartridge used in accordance with the method comprises:

a) a container; and

b) a water-wettable polymer packed within the container, wherein the polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

In yet another aspect, the invention provides a method of extracting FSVs from a fortified food matrix or a biological sample. The method comprises the steps of:

i) preparing an analytical sample containing the fortified food matrix or the biological sample;

ii) eluting the analytical sample through a column chromatography device with a first solvent; and

iii) eluting the column chromatography device with a second solvent. The column chromatography device used in accordance with the method comprises:

a) a column for accepting a stationary resin; and

b) a stationary resin comprising a polymer formed by copolymerizing at least one hydrophilic monomer and at least one hydrophobic monomer, wherein a ratio of a hydrophobic to hydrophilic monomer in the polymer is sufficient for the polymer to be water-wettable and effective for retaining organic solutes thereon, and wherein the polymer comprises greater than at least 12 mole percent of hydrophilic monomer.

In still another aspect, the invention provides a method of extracting FSVs from a fortified food matrix or a biological sample, with the method comprising the steps of:

i) preparing an analytical sample containing the fortified food matrix or the biological sample;

ii) eluting the analytical sample through a porous resin with a first solvent; and

iii) eluting the porous resin with a second solvent. The method makes use of a porous resin formed by:

a) copolymerizing at least one hydrophobic monomer and at least one hydrophilic monomer to form a polymer; and

b) subjecting the polymer to a sulfonation reaction to form a sulfonated polymer comprising at least one ion-exchange functional group, at least one hydrophilic component and at least one hydrophobic component.

The invention also provides a method of extracting FSVs from a fortified food matrix or a biological sample, which includes steps of:

i) preparing an analytical sample containing the fortified food matrix or the biological sample;

ii) eluting the analytical sample through a microtiter well plate with a first solvent; and

iii) eluting the microtiter well plate with a second solvent. The method makes use of a microtiter well plate comprising:

a) an open-ended container; and

b) a water-wettable polymer packed inside the open-ended container, wherein the polymer is formed by copolymerizing at least one hydrophobic monomer and at least one hydrophilic monomer having a hydrophilic to hydrophobic monomer ratio sufficient for the polymer to be water-wettable and effective to retain organic solutes thereon, wherein the polymer adsorbs a less polar solute more strongly than a more polar solute and wherein the solutes are capable of being desorbed from the polymer in order of decreasing polarity by washing the polymer with a sequence of solvents of decreasing polarity.

In a certain aspect, the invention also provides a method of extracting FSVs from a fortified food matrix or a biological sample comprising the steps of:

i) preparing an analytical sample containing the fortified food matrix or the biological sample;

ii) eluting the analytical sample through a solid phase extraction cartridge with a first solvent; and

iii) eluting the solid phase extraction cartridge with a second solvent. The solid phase solid phase extraction cartridge used in accordance with the method comprises:

a) a container; and

b) a sorbent bed packed inside the container, wherein the sorbent bed comprises a water-wettable polymer formed by copolymerizing at least one hydrophilic monomer and at least one hydrophobic monomer having a hydrophobic to hydrophilic monomer ratio sufficient for the polymer to be water-wettable and effective to retain organic solutes thereon, wherein the polymer adsorbs a less polar solute more strongly than a more polar solute and wherein the solutes are capable of being desorbed from the polymer in order of decreasing polarity by washing the polymer with a sequence of solvents of decreasing polarity.

Other aspects of the invention also include a method of extracting vitamin K₁ or K₂ from an analytical sample. The method comprises the steps of:

i) preparing the analytical sample from a food sample or a biological sample;

ii) eluting the analytical sample through a water-wettable polymer with a first solvent; and

iii) eluting the water-wettable polymer with a second solvent; wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

In certain embodiments, the hydrophilic monomer for copolymerization to form the polymer of the invention comprises a heterocyclic group, such as, a pyrrolidonyl group or a pyridyl group. In certain instances, the hydrophilic monomer is N-vinylpyrrolidone.

Certain embodiments of the invention provide that the hydrophobic monomer for copolymerization to form the polymer used in the invention comprises a phenyl group, a phenylene group, or a straight chain or branched C₂-C₁₈-alkyl group. The hydrophobic monomer can be, for example, styrene and divinylbenzene.

In one embodiment, the polymer of the invention used in the sorbent bed is poly(divinylbenzene-co-N-vinylpyrrolidone).

The methods of the invention can be used to extract fortified food matrices obtained from diary products, baby formula, multi-vitamins, energy bars, juices, soy milk and related products, chocolate, cereals, baked goods, and food supplements.

The methods of the invention can also be used to extract FSVs from biological samples, such as, blood, plasma, or urine.

In certain embodiments, the methods of the invention provides a simultaneous extraction of all FSVs contained in a sample matrix (e.g., a fortified food matrix, and a biological sample). In certain instances, the methods of the invention can simultaneously extract nine forms of FSVs, namely, retinol (A), retinyl acetate (A-acetate), retinyl palmitate (A-palmitate), ergocalciferol (D2), cholecalciferol (D3), alpha-tocopherol (E), alpha-tocopherol acetate (E-acetate), phylloquinone (K1) and menaquinone (K2) from a range of food matrices and biological samples. In certain instances, beta-carotine (provitamin A) that is contained in the sample matrices is simultaneously extracted.

According to certain aspects of the invention, the methods use a two-step elution process: eluting the analytical sample through the sorbent bed (such as, a porous resin, polymer, particles, packed beds, and monoliths) with a first solvent; and eluting the sorbent bed with a second solvent. Each of the first solvent and the second solvent used herein, independently, is selected from the group consisting of water, methanol, ethanol, isopropyl alcohol, acetonitrile, ethyl acetate, or a combination thereof.

In one embodiment, the first solvent used herein is a combination of isopropyl alcohol and acetonitrile. One example provides that the first solvent is a combination of isopropyl alcohol and acetonitrile at 1:1 ratio (v/v).

In another embodiment, the second solvent used in the two-step elution process is a combination of ethyl acetate and acetonitrile, such as, a combination of 20% (vol.) of ethyl acetate in acetonitrile.

According to certain embodiments of the invention, the analytical sample loaded onto the sorbent bed for the solid phase extraction is prepared by a procedure comprising extracting a sample (e.g., a fortified food matrix or a biological sample) using an organic solvent. Such an organic solvent can be, for example, methanol, ethanol, propanol, isopropyl alcohol, and a mixture thereof. In one embodiment, the organic solvent is ethanol.

The methods of the invention may also include steps of collecting supernatant resulted from the extracting step, and diluting the collected supernatant with water in preparing the analytical sample.

In certain embodiments, the analytical sample as prepared may contain an organic phase at 70% or higher by volume.

The methods of the invention may further include an identification step of the FSVs using analytical instruments and/or techniques, such as, UPLC system, LC-MS/MS, mass spectrometry, MALDI-MS, ESI-MS, nuclear magnetic resonance, infrared analysis, flow injection analysis, capillary electrochromatography, ultraviolet detection or a combination thereof.

The methods of the invention may be used to extract FSVs from all kinds of food products, such as, vitamin-enriched foods.

### BRIEF DESCRIPTION OF THE DRAWINGS

FIG. 1 illustrates a FSV preparation and extraction protocol.

FIG. 2A-B are chromatograms generated from a sample matrix from infant formula: FIG. 2A is a chromatogram showing separation of FSVs obtained from the sample matrix; FIG. 2B is a chromatogram demonstrating that RADAR technology allows for simultaneous acquisition of MRM (A) and full scan data (B) in a single analysis run.

FIG. 3 is a chromatogram showing separation of FSVs from a sample matrix obtained from infant formula.

FIG. 4 is a chromatogram showing separation of FSVs from sample matrices obtained from infant formula.

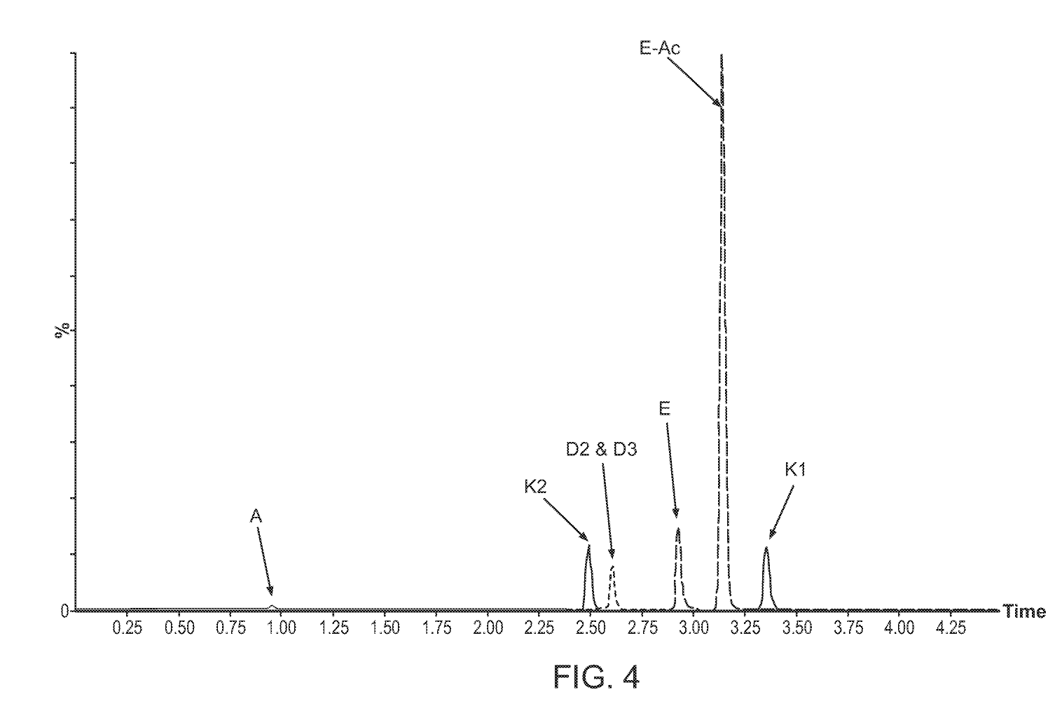

FIG. 5 depicts various OASIS® sorbent materials.

### DETAILED DESCRIPTION OF THE INVENTION

The present invention provides novel solid phase extraction methods for simultaneous extraction of fat soluble vitamins (FSVs) from a sample matrix from food products (e.g., a fortified food matrix) or biological samples, by eluting the sample matrix (or an analytical sample) through a sorbent bed (such as, a porous resin, or a water-wettable polymer packed inside of a solid phase extraction cartridge). The present invention will be more fully illustrated by reference to the definitions set forth below in the context of the following detailed description.

### DEFINITIONS

The term “sample” refers to any solution of a molecule or mixture of molecules that comprises at least one molecule that is subjected to extraction, separation, analysis or profiling. Particular examples include, but are not limited to, food samples (e.g., a fortified food matrix), and biological samples including a sample from human or animals (e.g., blood, blood plasma, urine, mucosal tissue secretions, tears, semen, and breast milk). The sample may further include macromolecules, e.g., substances, such as biopolymers, e.g., proteins, e.g., proteolytic proteins or lipophilic proteins, such as receptors and other membrane-bound proteins, and peptides. The sample may further include one or more lipid molecules.

The language “biological sample” refers to any solution or extract containing a molecule or mixture of molecules that comprises at least one biomolecule that is subjected to extraction or analysis that originated from a biological source (such as, humans and animals). Biological samples are intended to include crude or purified, e.g., isolated or commercially obtained, samples. Particular examples include, but are not limited to, inclusion bodies, biological fluids, biological tissues, biological matrices, embedded tissue samples, cells (e.g., one or more types of cells), and cell culture supernatants

The language “biological matrices” is intended to include anything that a cell contains or makes, e.g., bone, inclusion bodies, blood components, cells, e.g., cell lysates, etc.

The language “biological fluid” as used herein is intended to include fluids that are obtained from a biological source. Exemplary biological fluids include, but are not limited to, blood, blood plasma, urine, spinal fluid, mucosal tissue secretions, tears, interstitial fluid, synovial fluid, semen, and breast milk.

The language “fat-soluble vitamins” (FSVs) as used herein is intended to include various classes of compounds that can disperse and be stored in fat. Most likely, fat-soluble vitamins are compounds biologically active, e.g., have certain physiological functions. Fat-soluble vitamins are absorbed through the intestinal tract with the help of lipids (fats). Examples of fat-soluble vitamins include, such as, retinoids, olefins, D₂, D₃ and its precursors, tocopherols, menadiones, and menaquinones. In certain embodiments, fat-soluble vitamins as used herein include vitamins A, D, E and K or other forms known in the art.

The term “water-wettable” as used herein, describes a material which is solvated, partially or completely, by water. The material, thus, engages in energetically favorable or attractive interactions with water molecules. These interactions increase the amount of surface area of the material which, upon contact with water, is accessible to water molecules, and, hence, to solutes present in aqueous solution.

The term “monomer”, as used herein, refers to both a molecule comprising one or more polymerizable functional groups prior to polymerization, and a repeating unit of a polymer. A polymer can comprise two or more different monomers, in which case it can also be referred to as a copolymer. The “mole percent” of a given monomer which a copolymer comprises is the mole fraction, expressed as a percent, of the monomer of interest relative to the total moles of the various (two or more) monomers which compose the copolymer.

The terms “analysis” or “analyzing” are used interchangeably and refer to any of the various methods of separating, detecting, isolating, purifying, solubilizing, detecting and/or characterizing biological molecules (e.g., lipids). Examples include, but are not limited to, solid phase extraction, solid phase micro extraction, electrophoresis, mass spectrometry, e.g., MALDI-MS or ESI, liquid chromatography, e.g., high performance, e.g., reverse phase, normal phase, or size exclusion, ion-pair liquid chromatography, liquid-liquid extraction, e.g., accelerated fluid extraction, supercritical fluid extraction, microwave-assisted extraction, membrane extraction, soxhlet extraction, precipitation, clarification, electrochemical detection, staining, elemental analysis, Edmund degradation, nuclear magnetic resonance, infrared analysis, flow injection analysis, capillary electrochromatography, ultraviolet detection, and combinations thereof.

The term “profiling” refers to any of various methods of analysis which are used in combination to provide the content, composition, or characteristic ratio of biological molecules (e.g., a fat-soluble vitamin) in a sample.

The term “electrophoresis” refers to any of the various methods of analyzing small molecules by their rate of movement in an electric field, i.e. based on the charge to mass ratio of the molecules. Examples include, but are not limited to, free zone electrophoresis and capillary electrophoresis.

The term “mass spectrometric detection” refers to any of the various methods of mass spectroscopy. Examples include, but are not limited to, electrospray ionization (ESI), surface desorption ionization techniques, and atmospheric pressure chemical ionization (APCI).

The language “surface desorption ionization” is intended to include mass spectrometry, such as matrix assisted laser desorption ionization (MALDI-MS), desorption ionization on silicon (DIOS), thermal desorption mass spectrometry, or surface enhanced laser desorption ionization (SELDI) where desorption ionization is accomplished on a surface, with or without a matrix assistance.

“High Purity” or “high purity chromatographic material” includes a material which is prepared form high purity precursors. In certain aspects, high purity materials have reduced metal contamination and/or non-diminished chromatographic properties including, but not limited to, the acidity of surface silanols and the heterogeneity of the surface.

“Chromatographic core” includes a chromatographic materials, including but not limited to an organic material such as silica or a hybrid material, as defined herein, in the form of a particle, a monolith or another suitable structure which forms an internal portion of the materials of the invention. In certain aspects, the surface of the chromatographic core represents the chromatographic surface, as defined herein, or represents a material encased by a chromatographic surface, as defined herein. The chromatographic surface material may be disposed on or bonded to or annealed to the chromatographic core in such a way that a discrete or distinct transition is discernable or may be bound to the chromatographic core in such a way as to blend with the surface of the chromatographic core resulting in a gradation of materials and no discrete internal core surface. In certain embodiments, the chromatographic surface material may be the same or different from the material of the chromatographic core and may exhibit different physical or physiochemical properties from the chromatographic core, including, but not limited to, pore volume, surface area, average pore diameter, carbon content or hydrolytic pH stability

“Hydrophilic monomer” refers to a monomer containing a hydrophilic group (such as, a polar or charged functional group), rendering them soluble in water. In certain aspects, a hydrophilic group is a heterocyclic group, for example, a saturated, unsaturated or aromatic heterocyclic group. Suitable examples include nitrogen-containing heterocyclic groups such as pyrrolidonyl and pyridyl groups. In another embodiment, the hydrophilic moiety is an ether group. The hydrophilic monomer can be, for example, N-vinylpyrrolidone, 2-vinylpyridine, 3-vinylpyridine, a hydrophobic moiety, 4-vinylpyridine or ethylene oxide.

“Hydrophobic monomer” refers to a molecule or repeating unit of a polymer that is repelled from a mass of water. The hydrophobic monomer can comprise, for example, an aromatic carbocyclic group, such as a phenyl or phenylene group, or an alkyl group, such as a straight chain or branched C₂-C₁₈-alkyl group. Examples of hydrophobic monomers include, such as, styrene and divinylbenzene.

The term “alicyclic group” includes closed ring structures of three or more carbon atoms. Alicyclic groups include cycloparaffins or naphthenes which are saturated cyclic hydrocarbons, cycloolefins, which are unsaturated with two or more double bonds, and cycloacetylenes which have a triple bond. They do not include aromatic groups. Examples of cycloparaffins include cyclopropane, cyclohexane and cyclopentane. Examples of cycloolefins include cyclopentadiene and cyclooctatetraene. Alicyclic groups also include fused ring structures and substituted alicyclic groups such as alkyl substituted alicyclic groups. In the instance of the alicyclics such substituents can further comprise a lower alkyl, a lower alkenyl, a lower alkoxy, a lower alkylthio, a lower alkylamino, a lower alkylcarboxyl, a nitro, a hydroxyl, —CF3, —CN, or the like.

The term “aliphatic group” includes organic compounds characterized by straight or branched chains, typically having between 1 and 22 carbon atoms. Aliphatic groups include alkyl groups, alkenyl groups and alkynyl groups. In complex structures, the chains can be branched or cross-linked. Alkyl groups include saturated hydrocarbons having one or more carbon atoms, including straight-chain alkyl groups and branched-chain alkyl groups. Such hydrocarbon moieties may be substituted on one or more carbons with, for example, a halogen, a hydroxyl, a thiol, an amino, an alkoxy, an alkylcarboxy, an alkylthio, or a nitro group. Unless the number of carbons is otherwise specified, “lower aliphatic” as used herein means an aliphatic group, as defined above (e.g., lower alkyl, lower alkenyl, lower alkynyl), but having from one to six carbon atoms. Representative of such lower aliphatic groups, e.g., lower alkyl groups, are methyl, ethyl, n-propyl, isopropyl, 2-chloropropyl, n-butyl, sec-butyl, 2-aminobutyl, isobutyl, tert-butyl, 3-thiopentyl and the like. As used herein, the term “nitro” means —NO2; the term “halogen” designates —F, —Cl, —Br or —I; the term “thiol” means SH; and the term “hydroxyl” means —OH. Thus, the term “alkylamino” as used herein means an alkyl group, as defined above, having an amino group attached thereto. Suitable alkylamino groups include groups having 1 to about 12 carbon atoms, preferably from 1 to about 6 carbon atoms. The term “alkylthio” refers to an alkyl group, as defined above, having a sulfhydryl group attached thereto. Suitable alkylthio groups include groups having 1 to about 12 carbon atoms, preferably from 1 to about 6 carbon atoms. The term “alkylcarboxyl” as used herein means an alkyl group, as defined above, having a carboxyl group attached thereto. The term “alkoxy” as used herein means an alkyl group, as defined above, having an oxygen atom attached thereto. Representative alkoxy groups include groups having 1 to about 12 carbon atoms, preferably 1 to about 6 carbon atoms, e.g., methoxy, ethoxy, propoxy, tert-butoxy and the like. The terms “alkenyl” and “alkynyl” refer to unsaturated aliphatic groups analogous to alkyls, but which contain at least one double or triple bond respectively. Suitable alkenyl and alkynyl groups include groups having 2 to about 12 carbon atoms, preferably from 1 to about 6 carbon atoms.

The term “alkyl” includes saturated aliphatic groups, including straight-chain alkyl groups, branched-chain alkyl groups, cycloalkyl (alicyclic) groups, alkyl substituted cycloalkyl groups and cycloalkyl substituted alkyl groups. In certain embodiments, a straight chain or branched chain alkyl has 30 or fewer carbon atoms in its backbone, e.g., C1-C30 for straight chain or C3-C30 for branched chain. In certain embodiments, a straight chain or branched chain alkyl has 20 or fewer carbon atoms in its backbone, e.g., C1-C20 for straight chain or C3-C20 for branched chain, and more preferably 18 or fewer. Likewise, preferred cycloalkyls have from 4-10 carbon atoms in their ring structure and more preferably have 4-7 carbon atoms in the ring structure. The term “lower alkyl” refers to alkyl groups having from 1 to 6 carbons in the chain and to cycloalkyls having from 3 to 6 carbons in the ring structure.

Moreover, the term “alkyl” (including “lower alkyl”) as used throughout the specification and Claims includes both “unsubstituted alkyls” and “substituted alkyls”, the latter of which refers to alkyl moieties having substituents replacing a hydrogen on one or more carbons of the hydrocarbon backbone. Such substituents can include, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety. It will be understood by those skilled in the art that the moieties substituted on the hydrocarbon chain can themselves be substituted, if appropriate. Cycloalkyls can be further substituted, e.g., with the substituents described above. An “aralkyl” moiety is an alkyl substituted with an aryl, e.g., having 1 to 3 separate or fused rings and from 6 to about 18 carbon ring atoms, e.g., phenylmethyl (benzyl).

The term “amino,” as used herein, refers to an unsubstituted or substituted moiety of the formula —NRaRb, in which Ra and Rb are each independently hydrogen, alkyl, aryl, or heterocyclyl, or Ra and Rb, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. An “amino-substituted amino group” refers to an amino group in which at least one of Ra and Rb, is further substituted with an amino group.

The term “aromatic group” includes unsaturated cyclic hydrocarbons containing one or more rings. Aromatic groups include 5- and 6-membered single-ring groups which may include from zero to four heteroatoms, for example, benzene, pyrrole, furan, thiophene, imidazole, oxazole, thiazole, triazole, pyrazole, pyridine, pyrazine, pyridazine and pyrimidine and the like. The aromatic ring may be substituted at one or more ring positions with, for example, a halogen, a lower alkyl, a lower alkenyl, a lower alkoxy, a lower alkylthio, a lower alkylamino, a lower alkylcarboxyl, a nitro, a hydroxyl, —CF3, —CN, or the like.

The term “aryl” includes 5- and 6-membered single-ring aromatic groups that may include from zero to four heteroatoms, for example, unsubstituted or substituted benzene, pyrrole, furan, thiophene, imidazole, oxazole, thiazole, triazole, pyrazole, pyridine, pyrazine, pyridazine and pyrimidine and the like. Aryl groups also include polycyclic fused aromatic groups such as naphthyl, quinolyl, indolyl and the like. The aromatic ring can be substituted at one or more ring positions with such substituents, e.g., as described above for alkyl groups. Suitable aryl groups include unsubstituted and substituted phenyl groups. The term “aryloxy” as used herein means an aryl group, as defined above, having an oxygen atom attached thereto. The term “aralkoxy” as used herein means an aralkyl group, as defined above, having an oxygen atom attached thereto. Suitable aralkoxy groups have 1 to 3 separate or fused rings and from 6 to about 18 carbon ring atoms, e.g., O-benzyl.

The term “chiral moiety” is intended to include any functionality that allows for chiral or stereoselective syntheses. Chiral moieties include, but are not limited to, substituent groups having at least one chiral center, natural and unnatural amino-acids, peptides and proteins, derivatized cellulose, macrocyclic antibiotics, cyclodextrins, crown ethers, and metal complexes.

The term “heterocyclic group” includes closed ring structures in which one or more of the atoms in the ring is an element other than carbon, for example, nitrogen, sulfur, or oxygen. Heterocyclic groups can be saturated or unsaturated and heterocyclic groups such as pyrrole and furan can have aromatic character. They include fused ring structures such as quinoline and isoquinoline. Other examples of heterocyclic groups include pyridine and purine. Heterocyclic groups can also be substituted at one or more constituent atoms with, for example, a halogen, a lower alkyl, a lower alkenyl, a lower alkoxy, a lower alkylthio, a lower alkylamino, a lower alkylcarboxyl, a nitro, a hydroxyl, —CF3, —CN, or the like. Suitable heteroaromatic and heteroalicyclic groups generally will have 1 to 3 separate or fused rings with 3 to about 8 members per ring and one or more N, O or S atoms, e.g. coumarinyl, quinolinyl, pyridyl, pyrazinyl, pyrimidyl, furyl, pyrrolyl, thienyl, thiazolyl, oxazolyl, imidazolyl, indolyl, benzofuranyl, benzothiazolyl, tetrahydrofuranyl, tetrahydropyranyl, piperidinyl, morpholino and pyrrolidinyl.

The term “substantially disordered” refers to a lack of pore ordering based on x-ray powder diffraction analysis. Specifically, “substantially disordered” is defined by the lack of a peak at a diffraction angle that corresponds to a d value (or d-spacing) of at least 1 nm in an x-ray diffraction pattern.

“Surface modifiers” include (typically) organic functional groups which impart a certain chromatographic functionality to a chromatographic stationary phase. The porous inorganic/organic hybrid materials possess both organic groups and silanol groups which may additionally be substituted or derivatized with a surface modifier.

### Extraction and Determination of Fat-Soluble Vitamins

The present invention provides novel, simple, reliable and sensitive methods for simultaneous extraction of FSVs from a sample matrix like food products (e.g., a fortified food matrix) and biological samples through solid phase extraction (SPE). In one embodiment, the invention uses OASIS® HLB cartridge as a sample preparation/extraction tool.

Solid phase extraction (SPE) is a chromatographic technique of frequent use in the preparation of samples for quantitative analysis, for example, via high performance liquid chromatography (HPLC) or gas chromatography (GC) (McDonald and Bouvier, eds. Solid Phase Extraction Applications Guide and Bibliography, sixth edition, Milford, M A: Waters (1995)). Solid phase extraction can be used to separate a component of interest in a complex solution from potentially interfering matrix elements and to concentrate the analyte to levels amenable to detection and measurement. For example, solid phase extraction has been used in the analysis of environmental samples, pharmaceutical agents or metabolites in blood plasma, which requires the prior removal of plasma proteins and other matrix constituents which may interfere with the analysis.

Solid phase extraction of an aqueous solution is typically performed by passing the solution through a single-use cartridge containing a chromatographic sorbent. The most commonly used sorbents consist of porous silica particles that have been functionalized on their surface with hydrophobic octyl (C₈) and octadecyl (C₁₈) functional groups.

In particular, this invention provides simultaneous extraction, separation, determination, and/or identification of FSVs contained in complicated matrices, such as, fortified food products and biological samples, by using a solid-phase extraction method.

In certain instances, the invention provides methods for a simultaneous extraction, separation, or determination of seven FSVs from complicated sample matrices. The seven FSVs include vitamins A, D₂, D₃, E, E-acetate, K₁ and K₂, In other instances, the invention provides a simultaneous extraction, separation, or determination of nine FSVs from complicated sample matrices, including vitamins A, A-acetate, A-palmitate, D₂, D₃, E, E-acetate, K₁ and K₂. In certain embodiments, provitamin A may also be extracted together with one or more of the afore-mentioned FSVs.

In one aspect, the invention provides a method of extracting FSVs from a fortified food matrix or a biological sample. The method comprises the steps of:

i) preparing an analytical sample containing the fortified food matrix or the biological sample;

ii) eluting the analytical sample through a water-wettable polymer with a first solvent; and

iii) eluting the water-wettable polymer with a second solvent;

wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

In another aspect, the invention provides a method of extracting FSVs from a fortified food matrix or a biological sample including the steps of:

i) preparing an analytical sample containing the fortified food matrix or the biological sample;

ii) eluting the analytical sample through a solid phase extraction cartridge with a first solvent; and iii) eluting the solid phase extraction cartridge with a second solvent. The method makes use of a solid phase extraction cartridge comprising:

a) a container; and

b) a water-wettable polymer packed within the container, wherein the polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

In yet another aspect, the invention provides a method of extracting FSVs from a fortified food matrix or a biological sample. The method comprises the steps of:

i) preparing an analytical sample containing the fortified food matrix or the biological sample;

ii) eluting the analytical sample through a column chromatography device with a first solvent; and iii) eluting the column chromatography device with a second solvent. The column chromatography device used in accordance with the method comprises:

a) a column for accepting a stationary resin; and

b) a stationary resin comprising a polymer formed by copolymerizing at least one hydrophilic monomer and at least one hydrophobic monomer, wherein a ratio of a hydrophobic to hydrophilic monomer in the polymer is sufficient for the polymer to be water-wettable and effective for retaining organic solutes thereon, and wherein the polymer comprises greater than at least 12 mole percent of hydrophilic monomer.

In still another aspect, the invention provides a method of extracting FSVs from a fortified food matrix or a biological sample, with the method comprising the steps of:

i) preparing an analytical sample containing the fortified food matrix or the biological sample;

ii) eluting the analytical sample through a porous resin with a first solvent; and

iii) eluting the porous resin with a second solvent. The method makes us e of a porous resin is formed by:

a) copolymerizing at least one hydrophobic monomer and at least one hydrophilic monomer to form a polymer; and

b) subjecting the polymer to a sulfonation reaction to form a sulfonated polymer comprising at least one ion-exchange functional group, at least one hydrophilic component and at least one hydrophobic component.

The invention also provides a method of extracting FSVs from a fortified food matrix or a biological sample. The method includes steps of:

i) preparing an analytical sample containing the fortified food matrix or the biological sample;

ii) eluting the analytical sample through a microtiter well plate with a first solvent; and

iii) eluting the microtiter well plate with a second solvent. The method makes use of a microtiter well plate that comprises:

a) an open-ended container; and

b) a water-wettable polymer packed inside the open-ended container, wherein the polymer is formed by copolymerizing at least one hydrophobic monomer and at least one hydrophilic monomer having a hydrophilic to hydrophobic monomer ratio sufficient for the polymer to be water-wettable and effective to retain organic solutes thereon, wherein the polymer adsorbs a less polar solute more strongly than a more polar solute and wherein the solutes are capable of being desorbed from the polymer in order of decreasing polarity by washing the polymer with a sequence of solvents of decreasing polarity.

In another aspect, the invention provides a method of extracting FSVs from a fortified food matrix or a biological sample. The method includes the steps of:

i) preparing an analytical sample containing the fortified food matrix or the biological sample;

ii) eluting the analytical sample through a solid phase extraction cartridge with a first solvent; and

iii) eluting the solid phase extraction cartridge with a second solvent. The method makes us of a solid phase extraction cartridge comprising:

a) a container; and

b) a sorbent bed packed inside the container, wherein the sorbent bed comprises a water-wettable polymer formed by copolymerizing at least one hydrophilic monomer and at least one hydrophobic monomer having a hydrophobic to hydrophilic monomer ratio sufficient for the polymer to be water-wettable and effective to retain organic solutes thereon, wherein the polymer adsorbs a less polar solute more strongly than a more polar solute and wherein the solutes are capable of being desorbed from the polymer in order of decreasing polarity by washing the polymer with a sequence of solvents of decreasing polarity.

Another aspect of the invention provides a method of extracting vitamin K₁ or K₂ from an analytical sample. The method comprises the steps of:

i) preparing the analytical sample from a food sample or a biological sample;

ii) eluting the analytical sample through a water-wettable polymer with a first solvent; and

iii) eluting the water-wettable polymer with a second solvent; wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

The sample matrix (or the analytical sample) can be contacted with the polymer in any fashion which permits intimate contact of the polymer and the sample, such as, a batch or chromatographic process. For example, the sample matrix can be forced onto a porous polymer column, disk or plug, or the sample matrix can be stirred with the polymer, such as in a batch-stirred reactor. The sample matrix can also be added to a polymer-containing well of a microtiter plate. The polymer can take the form of, for example, beads or pellets. The analytical sample is contacted with the polymer for a time period sufficient for the molecules of interest (such as, FSVs) to substantially adsorb onto the polymer. This is typically the time that advantageously allows the molecules to equilibrate between the polymer surface and any solution contained in the sample matrix.

According to certain embodiments of the invention, the analytical sample (or the sample matrix) loaded onto the sorbent bed for the solid phase extraction is prepared by a procedure comprising extracting a sample (e.g., a fortified food matrix or a biological sample) using an organic solvent. Such an organic solvent can be, for example, methanol, ethanol, propanol, isopropyl alcohol, tetrahydrofuran, N,N-dimethylformamide, and dimethylsulfoxide, and a mixture thereof. In one embodiment, the organic solvent is ethanol.

In other embodiments of the invention, the analytical sample (or the sample matrix) is prepared by using one or more techniques including vortex, sonication and centrifugation.

The methods of the invention may also include steps of collecting supernatant resulted from the extracting step, and diluting the collected supernatant with water for the preparation of the analytical sample (or the sample matrix). In one embodiment, the sample matrix is first subjected to ethanol extraction and the collected supernatant is diluted with water for a later SPE. It is believed that a small amount of water is important for effective retention of FSVs on the SPE cartridge.

Conventional approaches in SPE dictates that the loading sample onto the sorbent bed should contain minimal organic solvent to achieve acceptable recoveries. Contrary to this widely accepted concept, the present invention can achieve good recoveries of FSVs when the analytical sample contain an organic phase at 70% or higher by volume. In certain embodiments, a good recovery of FSVs is achieved in presence of 100% organic phase in the analytical sample. In one embodiment, methanol is used as the organic phase.

In one embodiment, the solute of interest (such as, FSVs) adsorbs onto the polymer, but one or more additional solutes do not. Such an additional solute can be, for example, of sufficiently high polarity that it does not adsorb onto the polymer. The additional solute can also comprise large molecules, for example, macromolecules such as proteins, which are unable to pass through the pores within the polymer, and, thus, have access to only a small fraction of the overall polymer surface area. Such molecules are typically retained poorly, if at all, by the polymer.

In another embodiment, the additional solute or solutes are less polar than the solute of interest and, thus, adsorb to the polymer more strongly than the compound of interest. The compound of interest can be weakly to moderately adsorbed or not adsorbed. If adsorbed, the solute of interest is desorbed from the polymer by washing the polymer with a solvent of sufficient polarity that it does not desorb the additional solute or solutes. Thus, the compound of interest can be desorbed from the polymer without desorbing the other solutes.

In one embodiment, the additional solute or solutes are also analytes of interest. Thus a series of solutes initially present in a solution can be separated, and solutions of each suitable for quantitative analysis can be formed using the method of the present invention. In this case, the solution is contacted with the polymer so that the solutes adsorb to the polymer. The solutes are then desorbed from the polymer in order of decreasing polarity (i.e., most polar solute first, followed by solutes of successively decreasing polarity) by washing the polymer with a sequence of solvents of decreasing polarity.

According to certain embodiments of the invention, the methods use a two-step elution process: eluting the analytical sample (or the sample matrix) through a sorbent bed (such as, a porous resin, polymer, particles, packed beds, or monoliths) with a first solvent; and eluting the sorbent bed with a second solvent. The solvents used herein, independently, can be water, methanol, ethanol, isopropyl alcohol, acetonitrile, ethyl acetate, tetrahydrofuran, N,N-dimethylformamide, dimethylsulfoxide, or a combination thereof.

In one embodiment, the first solvent used herein is a combination of isopropyl alcohol and acetonitrile. One example provides that the first solvent is a combination of isopropyl alcohol and acetonitrile at 1:1 ratio (v/v).

In another embodiment, the second solvent used in the two-step elution process is a combination of ethyl acetate and acetonitrile, such as, a combination of 20% (vol.) of ethyl acetate in acetonitrile.

The methods of the invention can be used to extract all kinds of food matrices. In one embodiment, the methods of the invention can be used to extract all vitamin-enriched foods, such as, vitamin-D enriched food products (e.g., vitamin-D enriched milk).

In another embodiment, the methods of the invention can be used to extract fortified food matrices.

The food matrices that may be extracted include, but are not limited to, diary products, baby formula, multi-vitamins, energy bars, juices, soy milk and related products, chocolate, cereals, baked goods, food supplements, carrots, pumpkin, winter squash, dark green leafy vegetables, apricots, cantaloupe, liver, fish, fish oil, vegetable oil, margarine, shortening, wheat germ, whole grain products, nuts, egg yolks, and whole eggs.

The methods of the invention can also be used to extract FSVs from biological samples, such as, blood, blood plasma, urine, spinal fluid, mucosal tissue secretions, tears, interstitial fluid, synovial fluid, semen, and breast milk.

In certain embodiments, the invention provides a recovery of FSVs in the range between 77 to 112% out of the extraction, with a relative standard deviation (RSD) of less than 5%.

In certain aspects, the invention provides methods of extracting, separating, analyzing, concentrating or providing a sample matrix which comprises one or more fat-soluble vitamins. In certain embodiments, the sample is obtained from food products, animal feed, or biological samples. The biological samples include, such as, an inclusion body, a biological fluid, a biological tissue, a plant tissue, a biological matrix, an embedded tissue sample, one or more cells or a cell culture supernatant.

In other aspects, the invention provides a method of separating, analyzing, concentrating or providing a sample matrix further comprising the step of identifying the components of the sample matrix. Such identification can be is achieved by mass spectrometry, MALDI-MS, ESI-MS, nuclear magnetic resonance, infrared analysis, flow injection analysis, capillary electrochromatography, ultraviolet detection or a combination thereof.

In certain embodiments, the sample matrix may be concentrated, diluted, heated (for example, up to 40° C.) or cooled, prior to separation. In general, sample matrices can be prepared by any standard means generally known in the art. For example, sample matrices may be prepared, without limitation, by the methods disclosed in Bligh E G, Dyer W J (August 1959). “A rapid method of total lipid extraction and purification”. Can J Biochem Physiol 37 (8): 911-7. PMID 13671378; Krank J, Murphy R C, Barkley R M, Duchoslav E, McAnoy A (2007). “Qualitative analysis and quantitative assessment of changes in neutral glycerol lipid molecular species within cells”. Meth. Enzymol. 432: 1-20; Ivanova P T, Milne S B, Byrne M O, Xiang Y, Brown H A (2007). “Glycerophospholipid identification and quantitation by electrospray ionization mass spectrometry”. Meth. Enzymol. 432: 21-57; Deems R, Buczynski M W, Bowers-Gentry R, Harkewicz R, Dennis E A (2007). “Detection and quantitation of eicosanoids via high performance liquid chromatography-electrospray ionization-mass spectrometry”. Meth. Enzymol. 432: 59-82; McDonald J G, Thompson B M, McCrum E C, Russell D W (2007). “Extraction and analysis of sterols in biological matrices by high performance liquid chromatography electrospray ionization mass spectrometry”. Meth. Enzymol. 432: 145-70; Garrett T A, Guan Z, Raetz C R (2007). “Analysis of ubiquinones, dolichols, and dolichol diphosphate-oligosaccharides by liquid chromatography-electrospray ionization-mass spectrometry”. Meth. Enzymol. 432: 117-43; Sullards M C, Allegood J C, Kelly S, Wang E, Haynes C A, Park H, Chen Y, Merrill A H (2007). “Structure-specific, quantitative methods for analysis of sphingolipids by liquid chromatography-tandem mass spectrometry: “inside-out” sphingolipidomics”. Meth. Enzymol. 432: 83-115; or Å. Frostegård, A. Tunlid and E. Bååth (August 1991). “Microbial biomass measured as total lipid phosphate in soils of different organic content”. J. of Microbiological Methods 14: 151-163.

Analysis of extracts from the sample matrix may include, without limitation, UPLC system, solid phase extraction, solid phase micro extraction, electrophoresis, mass spectrometry, e.g., LC-MS/MS, MALDI-MS or ESI, liquid chromatography, e.g., high performance, reverse phase, normal phase, or size exclusion, ion-pair liquid chromatography, gas chromatography, liquid-liquid extraction, e.g., accelerated fluid extraction, supercritical fluid extraction, microwave-assisted extraction, membrane extraction, soxhlet extraction, precipitation, clarification, electrochemical detection, staining, elemental analysis, Edmund degradation, nuclear magnetic resonance, infrared analysis, flow injection analysis, capillary electrochromatography, ultraviolet detection, and combinations thereof.

In certain embodiments, analytes are analyzed using a UPLC system (such as, a WATERS ACQUITY UPLC system) coupled to a tandem quadrupole MS (such as, a XEVO TQ MS). A rapid six-minute UPLC-MS/MS method using positive atmospheric pressure chemical ionization (APCI) can be utilized for analysis of extracts (e.g. FSVs).

In other embodiments, the methods of the invention implement RADAR technologies for monitoring matrix interferences, impurities, and degradations in sample matrices.

In certain aspects, identification of components of the extracts is achieved by comparison of mass spectrometry peaks with known compounds in a computer database.

### Materials, Cartridges, and Related Devices

In certain embodiments, the methods of the invention use OASIS® sorbents as a sample preparation tool. OASIS® sorbents are water wettable, maintaining high retention and capacity for a wide spectrum of analytes, especially when the SPE column runs dry. Compared to conventional silica-based C18 sorbents, OASIS® sorbents maintain proper wetting for more consistent performance.

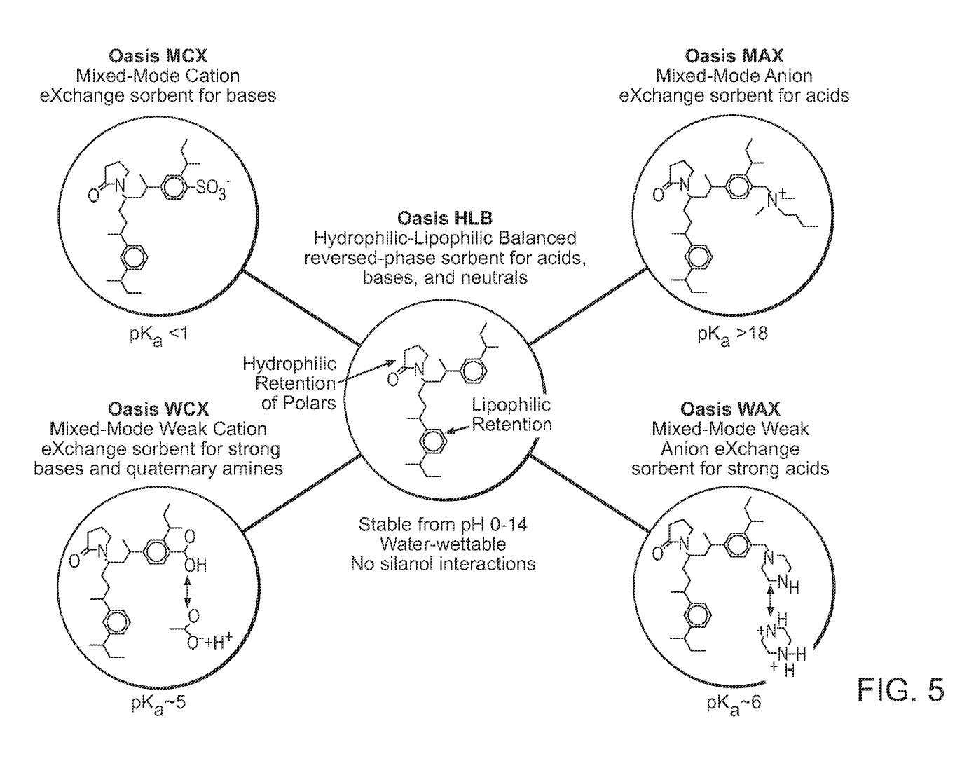

For example, the OASIS® HLB sorbent is a macroporous copolymer made from a balanced ratio of two monomers: a hydrophobic monomer and a hydrophilic monomer. It provides reversed-phase capability with a special “polar hook” for enhanced capture of polar analytes and excellent wettability. Other OASIS® sorbents include MCX, MAX, WCX, and WAX, featuring a mixed-mode retention mechanism (both ion exchange and reversed phase), which can be modified very predictably for maximum selectivity and sensitivity (see FIG. 5). It has been appreciated that the OASIS® sorbents provide a range of options for method development.

In other embodiments of the invention, the analytical sample (or the sample matrix) is contacted with a water-wettable polymer, which is formed by copolymerizing one or more hydrophobic monomers and one or more hydrophilic monomers, whereby analytical sample is adsorbed onto the polymer. The water-wettable polymer used herein has the ability to retain a variety of solutes of varying polarity.

In certain embodiments, the hydrophilic monomer used in the invention comprises a heterocyclic group, for example, a saturated, unsaturated or aromatic heterocyclic group. Suitable examples include nitrogen-containing heterocyclic groups such as pyrrolidonyl and pyridyl groups. In another embodiment, the hydrophilic moiety is an ether group. The hydrophilic monomer can be, for example, N-vinylpyrrolidone, 2-vinylpyridine, 3-vinylpyridine, a hydrophobic moiety, 4-vinylpyridine or ethylene oxide.

The hydrophobic monomer can comprise, for example, an aromatic carbocyclic group, such as a phenyl or phenylene group, or an alkyl group, such as a straight chain or branched C₂-C₁₈-alkyl group. Suitable hydrophobic monomers include, but are not limited to, styrene and divinylbenzene.

In one embodiment, the polymer is poly(divinylbenzene-co-N-vinylpyrrolidone). The polymer can comprise about 12 mole percent or more N-vinylpyrrolidone. In one embodiment, the polymer comprises from about 15 mole percent to about 30 mole percent N-vinylpyrrolidone.

The polymer can be in the form of, for example, beads having a diameter in the range from about 5 to about 500 μm, or even from about 20 to about 200 μm. The copolymer, preferably, has a specific surface area in the range from about 200 to about 800 square meters per gram and pores having a diameter ranging from about 0.5 nm to about 100 nm.

In certain embodiments, the polymer is packed as particles within an open-ended container to form a solid phase extraction cartridge. The container can be, for example, a cylindrical container or column which is open at both ends so that a solvent can enter the container through one end, elute the polymer within the container, and exit the container through the other end.

The polymer need not be pretreated or wetted prior to contacting a sample with the polymer. In one embodiment, the polymer is treated with a water-miscible organic solvent, followed by water or aqueous buffer, prior to contacting the sample with the polymer. In another embodiment, the sample is contacted with dry polymer, that is, the polymer is not wetted prior to treatment of the sample.

The container can be formed of any material which is compatible, within the time frame of the extraction process, with the solutions and solvents to be used in the procedure. Such materials include glass and various plastics, such as high density polyethylene and polypropylene. In one embodiment, the container is cylindrical through most of its length and has a narrow tip at one end. One example of such a container is a syringe barrel.

The solid phase extraction cartridge can further comprise a porous retaining means, such as a filter element, or frit, at one or both ends of the cartridge adjacent to the polymer to retain the polymer within the cartridge and to remove undissolved solid materials contained in the analytical sample during the loading and/or eluting process. Such a filter can be formed from, for example, fitted glass or a porous polymer, such as a porous high density polyethylene.

The amount of polymer within the container is limited by the container volume and can range from about 0.001 g to about 50 g, for example, between about 0.025 g and about 1 g. The amount of polymer suitable for a given extraction depends upon the amount of solute to be adsorbed, the available surface area of the polymer and the strength of the interaction between the solute and the polymer. This can be readily determined by one of ordinary skill in the art.

The cartridge used herein can be a single use cartridge, which is used for the treatment of a single sample and then discarded, or it can be used to treat multiple samples.

The polymers used as the sorbent bed in the methods of the invention can be prepared via standard synthetic methods. For example, a poly(divinylbenzene-co-N-vinylpyrrolidone) copolymer can be synthesized by copolymerization of divinylbenzene and N-vinylpyrrolidone using standard methods of free radical polymerization which are well known in the art. One method for forming copolymers of this type is disclosed in U.S. Pat. No. 4,382,124, issued to Meitzner et al., the contents of which are incorporated herein by reference. The composition of the resulting copolymer depends upon the starting stoichiometry of the two monomers and can be readily varied. The composition of the product copolymer in some cases will not be substantially the same as the proportion of the starting materials, due to differences in reactivity ratios among the monomers.

A detailed description of the materials (e.g., polymers, particles, packed beds, and monoliths) and devices that can be used in the present invention can be found, for example, in U.S. Pat. Nos. 5,882,521; 5,976,376; 6,106,721; 6,254,780; 6,322,695; 6,468,422; 6,726,842; 6,773,583; 6,723,236, each of which is incorporated herein in its entirety.

### EXAMPLES

The present invention may be further illustrated by the following non-limiting examples describing the methods of the invention.

### Example 1

### Sample Preparation and Extraction

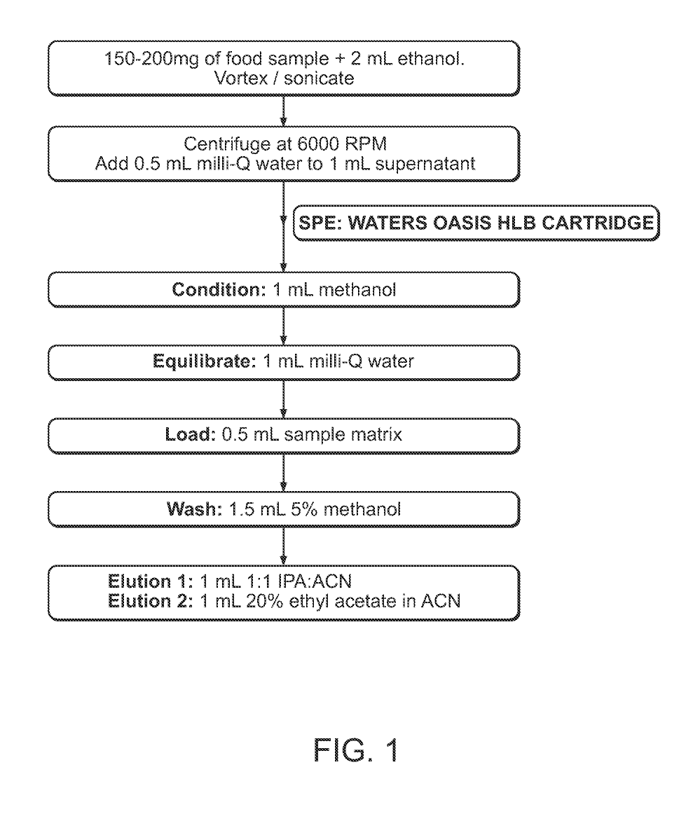

Sample matrix from infant formula (IF) was subjected to ethanol extraction followed by solid phase extraction (SPE) using WATERS OASIS® HLB Cartridge (60 mg, 3 cc). The preparation and extraction procedure was illustrated in FIG. 1 in detail.

After the extraction, eluted fractions were combined, evaporated to dryness, and then reconstituted with ethanol. The extracts were then analyzed using LC-MS/MS with conditions as follows:

### LC Conditions

Instrument: WATERS ACQUITY UPLC System

Column: ACQUITY UPLC BEH C18, 1.7 μm, 2.1×100 mm

Column temp: 40° C.

Mobile phase: A) 90:10 acetonitrile:water
B) methanol

Injection volume: 5 μL

Total run time: 6.0 min

Gradient

| Time (min) | % A | % B |
|---|---|---|
| 0.00 | 99.9 | 0.1 |
| 0.50 | 99.9 | 0.1 |
| 2.50 | 0.1 | 99.9 |
| 4.50 | 0.1 | 99.9 |
| 4.51 | 99.9 | 0.1 |
| 6.00 | 99.9 | 0.1 |

### MS Conditions

MS System: WATERS XEVO™ TQ MS system

Ionization: APCI positive

Corona current: 15 μA

Source Temp: 150° C.

APCI probe Temp: 550° C.

Desolvation gas: 1000 L/H

Acquisition: Multiple reaction monitoring (MRM) with RADAR full scan

Collision gas: Argon at 3.5×10⁻³ mbar

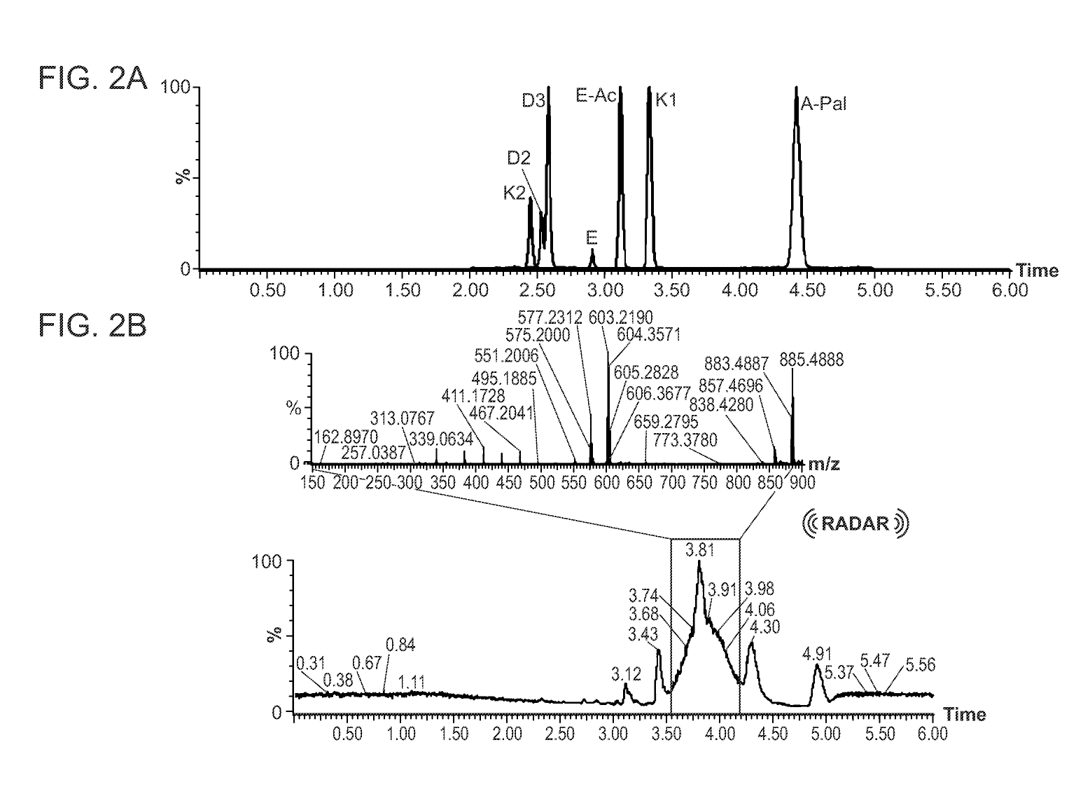

The chromatograms resulting from the analysis are presented in FIG. 2. Further, the results of the analysis are provided and summarized in the following Table 1:

TABLE 1

| | Parent | Dau 1/Dau 2 | CV | CE 1/CE 2 | RT |
|---|---|---|---|---|---|
| Analyte | (m/z) | (m/z) | (V) | (eV) | (min) |
| Vitamin A | 268.9 | 93 | 20 | 22 | 0.98 |
| (palmitate | | 81 | | 24 | (4.48) |
| form in IF) | | | | | |
| Vitamin K2 | 445.5 | 187.1 | 24 | 22 | 2.45 |
| | | 81 | | 46 | |
| Vitamin D2 | 397.5 | 107 | 20 | 20 | 2.53 |
| | | 379.4 | | 12 | |
| Vitamin D3 | 385.5 | 367.4 | 20 | 14 | 2.59 |
| | | 107 | | 24 | |
| Vitamin E | 431.5 | 165 | 18 | 26 | 2.91 |
| | | 137 | | 40 | |
| Vitamin E | 473.6 | 207.1 | 28 | 18 | 3.12 |
| acetate | | 165.1 | | 40 | |
| Vitamin K1 | 451.5 | 187.1 | 34 | 24 | 3.34 |
| | | 128 | | 74 | |

### Example 2

Sample matrices from various food products were prepared and extracted in accordance with the procedures set forth in Example 1 and the protocol provided in FIG. 1. The recoveries of FSVs from different matrices are provided in the following Table 2:

TABLE 2

| | % Recovery | | |
|---|---|---|---|
| Vitamins | Infant formula | Chocolate | Breakfast cereals* |
| A | 99.4 | 83.7 | 77.5 |
| D₂ | 87.9 | 82.9 | 102.2 |
| D₃ | 80.6 | 94.8 | 103.4 |
| E | 86.1 | 112.9 | 111.3 |
| E acetate | 84.9 | 107.6 | 99.2 |
| K₁ | 77.9 | 84.6 | 111.9 |
| K₂ | 91.4 | 84.0 | 116.9 |

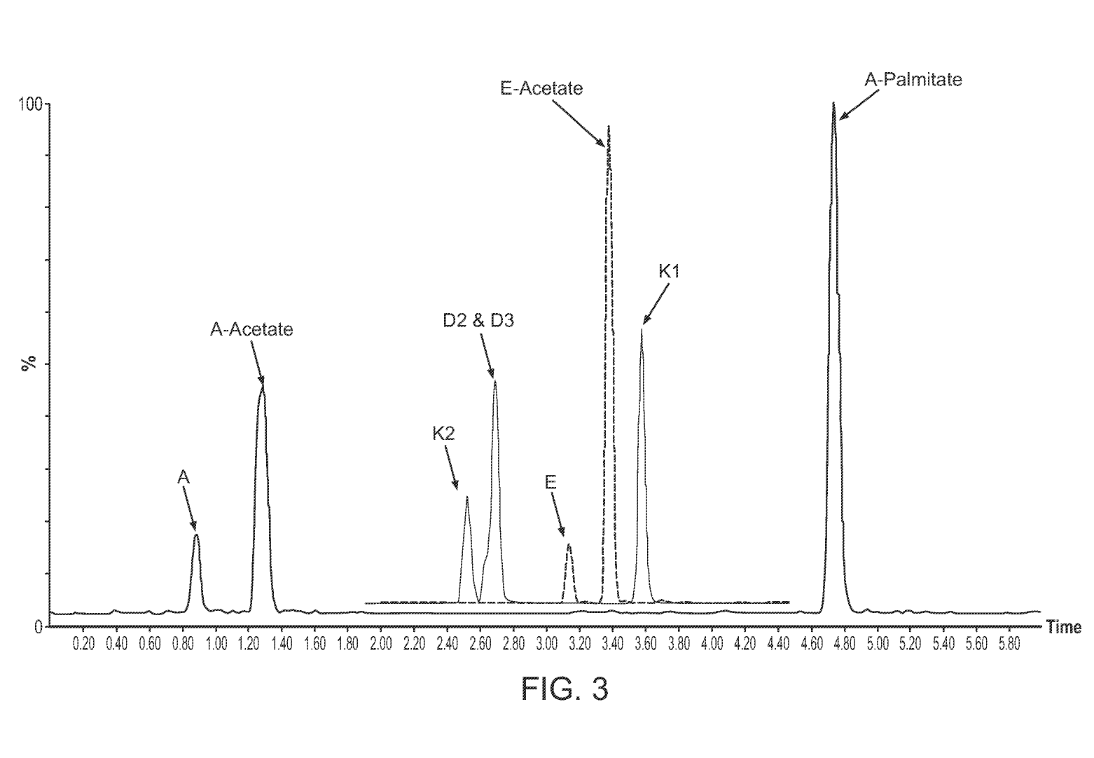

In addition, in the sample matrix from infant formula, a recovery of 95.3% of vitamin A-acetate and 101.2% of vitamin A-Palmitate was obtained (see also FIG. 3).

### Example 3

Sample matrices from Infant formula, chocolate and breakfast cereals were prepared and extracted according to the following protocol (simplified):

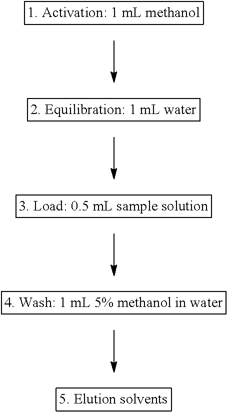

OASIS® HLB cartridge (3 cc, 60 mg) was used as the sample separation tool. Table 3 presents recovery results of FSVs when different elution solvents were used.

TABLE 3

| | % RECOVERY | | | |
|---|---|---|---|---|
| | | 1:1 | 1:1 | 1:2 |
| Vitamins | ACN | Ethanol:ACN | IPA:ACN | IPA:ACN |
| Vit A | 75 | 91 | 105 | 97 |
| Vit D₂ | 56 | 109 | 100 | 93 |
| Vit D₃ | 45 | 113 | 108 | 120 |
| Vit E | 25 | 79 | 92 | 73 |
| Vit E Acetate | 59 | 84 | 89 | 74 |
| Vit K₁ | 33 | 15 | 25 | 37 |
| Vit K₂ | 43 | 26 | 26 | 49 |

IPA: Isopropyl alcohol; ACN: Acetonitrile

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents are considered to be within the scope of this invention and are covered by the following claims.

1. A method of extracting fat soluble vitamins from a fortified food matrix or a biological sample comprising the steps of:
i) preparing an analytical sample containing the fortified food matrix or the biological sample;
ii) eluting the analytical sample through a water-wettable polymer with a first solvent; and
iii) eluting the remaining analytes through the water-wettable polymer with a second solvent;
wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

2-6. (canceled)

7. The method of claim 1, wherein the hydrophilic monomer comprises a heterocyclic group.

8. The method of claim 7, wherein the heterocyclic group is a pyrrolidonyl group or a pyridyl group.

9. The method of claim 7, wherein the hydrophilic monomer is N-vinylpyrrolidone.

10. The method of claim 1, wherein the hydrophobic monomer comprises a phenyl group, a phenylene group, or a straight chain or branched C2-C18-alkyl group.

11. The method of claim 10, wherein the hydrophobic monomer is styrene or divinylbenzene.

12. The method of claim 1, wherein the polymer is poly(divinylbenzene-co-N-vinylpyrrolidone).

13. The method of claim 1, wherein the fortified food matrix is obtained from diary products, baby formula, multi-vitamins, energy bars, juices, soy milk and related products, chocolate, cereals, baked goods, or food supplements.

14. The method of claim 1, wherein the biological sample is blood, plasma, or urine.

15. The method of claim 1, wherein the method provides a simultaneous extraction of all fat soluble vitamins contained in the fortified food matrix or the biological sample.

16. The method of claim 1, wherein the method provides a simultaneous extraction of fat soluble vitamins comprising vitamins A, D2, D3, E, E-acetate, K1 and K2.

17. The method of claim 1, wherein the fat soluble vitamins further comprise vitamins A-acetate and A-palmitate.

18. The method of claim 1, wherein the first solvent and the second solvent, each independently, is selected from the group consisting of water, methanol, ethanol, isopropyl alcohol, acetonitrile, ethyl acetate, and a combination thereof.

19. The method of claim 18, wherein the first solvent is a combination of isopropyl alcohol and acetonitrile, and the second solvent is a combination of ethyl acetate and acetonitrile.

20. The method of claim 19, wherein the first solvent is a combination of isopropyl alcohol and acetonitrile at 1:1 ratio (v/v), and the second solvent is a solvent of 20% (wt) of ethyl acetate in acetonitrile.

21. The method of claim 1, wherein the analytical sample is prepared by a procedure comprising extracting the fortified food matrix or the biological sample using an organic solvent selected from the group consisting of methanol, ethanol, propanol, isopropyl alcohol, and a mixture thereof.

22. The method of claim 21, wherein the organic solvent is ethanol.

23. The method of claim 21, wherein the procedure for preparing the analytical sample further comprises the steps of collecting supernatant resulted from the extracting step, and diluting the collected supernatant with water.

24. The method of claim 23, wherein the analytical sample comprises an organic phase at 70% or higher by volume.

25. The method of claim 1, further comprising identifying the fat soluble vitamins by UPLC system, LC-MS/MS, mass spectrometry, MALDI-MS, ESI-MS, nuclear magnetic resonance, infrared analysis, flow injection analysis, capillary electrochromatography, ultraviolet detection, or a combination thereof.

26. A method of extracting vitamin K1 from an analytical sample comprising the steps of:
i) preparing the analytical sample from a food sample or a biological sample;
ii) eluting the analytical sample through a water-wettable polymer with a first solvent; and
iii) eluting the water-wettable polymer with a second solvent;
wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

27. A method of extracting vitamin K2 from an analytical sample comprising the steps of:
i) preparing the analytical sample from a food sample or a biological sample;
ii) eluting the analytical sample through a water-wettable polymer with a first solvent; and
iii) eluting the water-wettable polymer with a second solvent;
wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

28. A method of simultaneously extracting vitamin K1 and K2 from an analytical sample comprising the steps of:
i) preparing the analytical sample from a food sample or a biological sample;
ii) eluting the analytical sample through a water-wettable polymer with a first solvent; and
iii) eluting the water-wettable polymer with a second solvent;
wherein the water-wettable polymer is formed by copolymerizing at least one hydrophilic monomer and at least one hydrophobic monomer having a hydrophobic to hydrophilic monomer ratio sufficient for the polymer to be water-wettable and effective to retain organic solutes thereon, and wherein the polymer comprises greater than at least 12 mole percent of hydrophilic monomer.

29. The method of claim 1, wherein the water-wettable polymer is contained in a solid phase extraction cartridge, a microtiter well plat, or a column chromatography device.
